(19) United States
(12) Patent Application Publication
(10) Pub. No.: US 2015/0046517 A1
(43) Pub. Date: Feb. 12, 2015

(54) INFORMATION DELIVERY SYSTEM AND CLIENT TERMINAL

(71) Applicant: HONDA MOTOR CO., LTD., Tokyo (JP)

(72) Inventors: Tomoko HANDA, Kawagoe-shi (JP); Hiromitsu YUHARA, Tokyo (JP); Kazuya TAMURA, Tokyo (JP)

(21) Appl. No.: 14/328,952

(22) Filed: Jul. 11, 2014

(30) Foreign Application Priority Data
Aug. 7, 2013 (JP) 2013-164594

(51) Int. Cl. H04L 29/08

(52) U.S. Cl. CPC H04L 67/26
USPC 709/203

(57) ABSTRACT

A client terminal of an information delivery system displays questions for diagnosing the personality of a user, and multiple choices as answers to the questions on a personality diagnosing screen. After any of the multiple choices have been selected by the user, delivery settings corresponding to the selected multiple choices are selected as initial values, and the delivery settings are transmitted to the server in the form of the initial values as is, or after changes have been made thereto by the user.

### CROSS-REFERENCE TO RELATED APPLICATION

This application is based upon and claims the benefit of priority from Japanese Patent Application No. 2013-164594 filed on Aug. 7, 2013, the contents of which are incorporated herein by reference.

### BACKGROUND OF THE INVENTION

1. Field of the Invention

The present invention relates to a client terminal, and an information delivery system which is equipped with the client terminal and a server that carries out push distribution of various information with respect to the client terminal.

2. Description of the Related Art

A push distribution system is known that carries out push distribution of various information (also referred to as “content”) conforming to user attributes from a server to a client terminal (see Japanese Laid-Open Patent Application No. JP 2000-067067, hereinafter referred to as “JP 2000-067067 A”, and Japanese Laid-Open Patent Application No. JP 10-134076, hereinafter referred to as “JP 10-134076 A”). With such a system, it is necessary for user attributes to be entered (i.e., input) into the client terminal. In JP 2000-067067 A, for entering user attributes, a dialog box or the like is displayed on a client terminal for directing registration of user attributes, thereby prompting the user to register the user attributes (see paragraph [0023]).

In JP 10-134076 A, a user selects pre-defined keywords in which the user has interest from a keyword table, and the selected keywords are registered in a user information table 10 through an input unit 15 by the user or a system administrator (see paragraph [0025]). Further, an information acquiring computer 3 is connected through a network to an information supplying computer 1, wherein from the information acquiring computer 3, the keywords may be registered by the user in a region (keyword ID29) of the user information table 10 (see paragraph [0025]).

### SUMMARY OF THE INVENTION

In order to offer a delivery service, which is capable of satisfying a user who desires information responsive to the needs and preferences of the user, it is necessary for multiple delivery setting items corresponding to the needs and preferences of the user to be provided.

However, if the delivery setting items are increased in number, the time required for the user to read and understand such items, and the effort needed for the user to judge the items and perform setting operations for such items also increases.

Further, cases occur in which it may be difficult for the content of the delivery setting items to be understood simply by observing the names of the various delivery setting items. In addition, concerning items that are not familiar to the user, it may be difficult for the user to determine the content to be set therefor. Moreover, by allowing settings to be carried out based on preconceived notions of the user in relation to the delivery setting items, there is a concern that important delivery settings may be neglected, or that the settings will not be made properly.

The present invention has been devised taking into consideration the aforementioned problems, and has the object of providing an information delivery system and a client terminal, in which beneficial delivery settings can be made for the user, while alleviating the effort required from the user in relation to such delivery settings.

An information delivery system according to the present invention includes a client terminal, and a server that carries out push distribution of various information with respect to the client terminal. The client terminal displays a personality diagnosing screen by which a question for diagnosing the personality of a user, and multiple choices as answers to the question are displayed. After any of the multiple choices have been selected by the user, the client terminal selects as initial values delivery settings corresponding to the selected multiple choices, and transmits the delivery settings to the server in the form of the initial values as is, or after changes have been made thereto by the user. The server carries out push distribution of the various information with respect to the client terminal, corresponding to the delivery settings received from the client terminal.

According to the present invention, initial values for delivery settings can be selected for carrying out push distribution according to user responses accompanying the personality diagnosis. Therefore, it is possible to alleviate the effort required from the user in relation to such delivery settings. In particular, it is possible to enhance user convenience when the delivery settings are first input.

Further, in the event that, among the delivery settings, there are items for which the content thereof is difficult to understand, items of which the user is unaware, or items that are mistaken by the user (e.g., items that the user has decided are unnecessary, but in actuality, such items would be of great interest to the user), it is possible for delivery settings to be made that are beneficial to the user. In particular, with the present invention, by way of the personality diagnosis, it is highly possible for information to be delivered that is beneficial to the user, without forcing the user to possess a deep understanding in relation to the delivery settings.

Furthermore, the results of the personality diagnosis can be used as representing the user's personality. Thus, by associating the results of the personality diagnosis and the delivery settings using psychological knowledge, delivery settings can be realized which are more beneficial or advantageous for the user.

The client terminal may display a delivery settings confirmation screen by which the delivery settings corresponding to the selected choices are selected as the initial values, the delivery settings confirmation screen enabling the delivery settings to be changed responsive to an operation of the user. Consequently, compared to the case of confirming the delivery settings responsive to results of the personality diagnosis, the will of the user can be more easily reflected. Therefore, it is possible to carry out delivery of information while respecting the intention of the user.

In addition to variable initial value settings, which are delivery settings selected as initial values corresponding to the selected choices, the client terminal may select as delivery settings fixed initial value settings, which are delivery settings that are specified without relation to the selection of such choices.

Owing thereto, delivery settings (variable initial value settings) in which the initial values therefor are variable corresponding to results of the personality diagnosis can be used together with delivery settings (fixed initial value settings) in which initial values therefor are set irrespective of the results of the personality diagnosis. Along therewith, unintentional omission of settings concerning delivery settings that are normally necessary (for example, delivery of disaster information) can be prevented.

A client terminal according to the present invention receives by way of push distribution various information from a server, wherein the client terminal displays a personality diagnosing screen by which a question for diagnosing the personality of a user, and multiple choices as answers to the question are displayed. After any of the multiple choices have been selected by the user, the client terminal selects as initial values delivery settings corresponding to the selected multiple choices, and transmits the delivery settings to the server in the form of the initial values as is, or after changes have been made thereto by the user.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram showing an overall configuration of an information delivery system according to an embodiment of the present invention;

FIG. 2 is a flowchart of steps performed when a client terminal acquires a delivery settings program;

FIG. 3 is a flowchart of steps performed upon initial entry of delivery settings in the client terminal;

FIG. 4 is a view showing an example of a personality diagnosis start screen;

FIG. 5 is a view showing an example of a personality diagnosis screen;

FIG. 6 is a view showing an example of a diagnostic result display screen;

FIG. 7 is a view showing an example of a delivery settings confirmation screen;

FIG. 8 is a view showing the presence or absence of switching of initial values corresponding to personality types, and recommended information categories and sub-categories to be delivered according to the present embodiment; and

FIG. 9 is a view showing a relationship between personality types as judged by the personality diagnosis, and categories for which initial values of the delivery settings are turned on.

### DESCRIPTION OF THE PREFERRED EMBODIMENTS

### A. Embodiment

### 1. Configuration

### 1-1. Overall Configuration

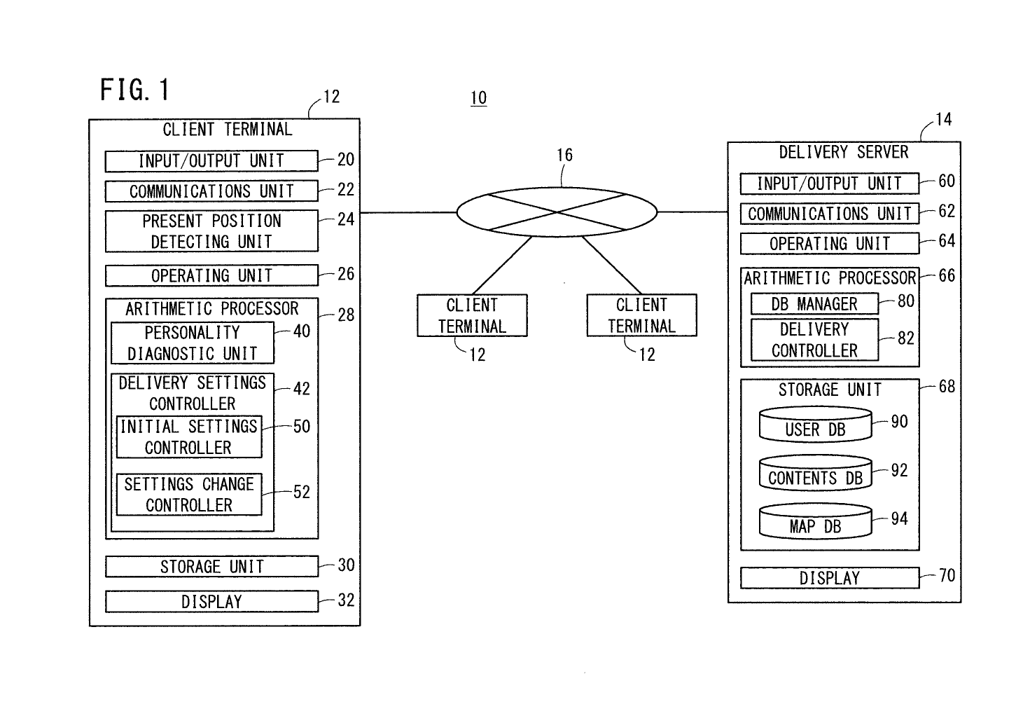

FIG. 1 is a block diagram showing an overall configuration of an information delivery system 10 (hereinafter also referred to as a “system 10”) according to an embodiment of the present invention. The system 10 is equipped with a plurality of client terminals 12 (hereinafter also referred to as “terminals 12”), and a distribution server 14 (hereinafter also referred to as a “server 14”). In the present embodiment, the server 14 and each of the client terminals 12 are capable of communication with each other via a communications network 16.

### 1-2. Client Terminal 12

As shown in FIG. 1, the client terminal 12 includes an input/output unit 20, a communications unit 22, a present position detecting unit 24, an operating unit 26, an arithmetic processor 28, a storage unit 30, and a display 32. The input/output unit 20 carries out input and output of signals in the client terminal 12. The communications unit 22 carries out communications with the server 14 via a wired or wireless network. The present position detecting unit 24 detects the present position of the terminal 12. The operating unit 26 comprises an input device such as a touch panel or the like for input of instructions from the user.

The arithmetic processor 28 controls respective components of the client terminal 12, and comprises a personality diagnosing unit 40 and a delivery settings controller 42. As will be described later, the personality diagnosing unit 40 and the delivery settings controller 42 are formed through execution of a delivery settings program Pd, for carrying out display of information on the display 32. The personality diagnosing unit 40 performs a personality diagnosis on the user for the purpose of defining the delivery settings. The delivery settings controller 42 controls input or selection of the delivery settings. In this case, the delivery settings serve to carry out push distribution of various information (hereinafter also referred to as “recommended information Irec”) from the server 14 to the client terminal 12.

The delivery settings controller 42 includes an initial settings controller 50 and a settings change controller 52. The initial settings controller 50 controls the initial values (initial settings) of the delivery settings. At this time, a portion of the initial settings are selected corresponding to the result (personality type) of the personality diagnosis. The settings change controller changes the delivery settings responsive to operations of the user.

The storage unit 30 stores various programs and data for control programs and the like that are used by the arithmetic processor 28. Among the various data, there is included user information of the client terminal 12. Further, among the user information, there is included user identifying information (user ID) for the purpose of specifying the user or the client terminal 12. The display 32 displays various screens, etc., which are used in relation to the delivery settings. If the operating unit 26 is a touch panel, the operating unit 26 and the display 32 can be constituted together as the same unit.

As hardware that makes up the client terminal 12, for example, a commercially available smart phone can be used.

### 1-3. Server 14

As shown in FIG. 1, the server 14 comprises an input/output unit 60, a communications unit 62, an operating unit 64, an arithmetic processor 66, a storage unit 68, and a display 70. The input/output unit 60 carries out input and output of signals in the server 14. The communications unit 62 carries out communications with each of the client terminals 12 via a wired or wireless network. The operating unit 64 comprises an input device such as a keyboard for input of instructions from an administrator of the server 14.

The arithmetic processor 66 controls respective components of the server 14, and comprises a database management unit 80 (hereinafter referred to as a “DB manager 80”) and a delivery controller 82. The DB manager 80 manages a database included within the storage unit 68. The delivery controller 82 controls push distribution of various information (recommended information Irec) from the server 14 to the respective client terminals 12.

The storage unit 68 stores various programs and data for control programs and the like that are used by the arithmetic processor 66. The storage unit 68 includes a user database 90 (hereinafter referred to as a “user DB 90”), a contents database 92 (hereinafter referred to as a “contents DB 92”), and a map database 94 (hereinafter referred to as a “map DB 94”).

In the user DB 90, information (personal data) is contained in relation to users of the respective client terminals 12. As information related to users, there may be included the name, sex, birth date (age), and a user ID, for example.

In the contents DB 92, contents are contained as recommended information Irec. As examples of such content, there may be included items such as music, various news, various articles, event information, etc., intended for users. The map DB 94 includes various types of map information (e.g., information of facilities, properties, etc.)

### 2. Various Controls

### 2-1. Overview

Below, a description will be made of various controls performed in the client terminals 12 and the distribution server 14, until a point at which push distribution of recommended information Irec is carried out from the distribution server 14 with respect to a specified client terminal 12. According to the present embodiment, at first, using a client terminal 12, the user acquires (downloads and installs) a delivery settings program Pd. The delivery settings program Pd is a program for implementing delivery settings in the client terminal 12.

The delivery settings program Pd of the present embodiment includes as a portion thereof a personal assistant application program (hereinafter referred to as a “PAAP”). The PAAP is a program implemented by the client terminal 12, for enabling push distribution of information, as recommended information Irec to the client terminals 12, corresponding to respective attributes (personal data) of each of the users of the client terminals 12.

After the PAAP including the delivery settings program Pd is acquired, the user carries out input of delivery settings by operating the client terminal 12. When input of the delivery settings is completed, the concerned delivery settings are transmitted to the server 14. The server 14 then delivers by way of push distribution the recommended information Irec corresponding to the delivery settings received from the client terminal 12.

### 2-2. Acquisition of Delivery Settings Program Pd

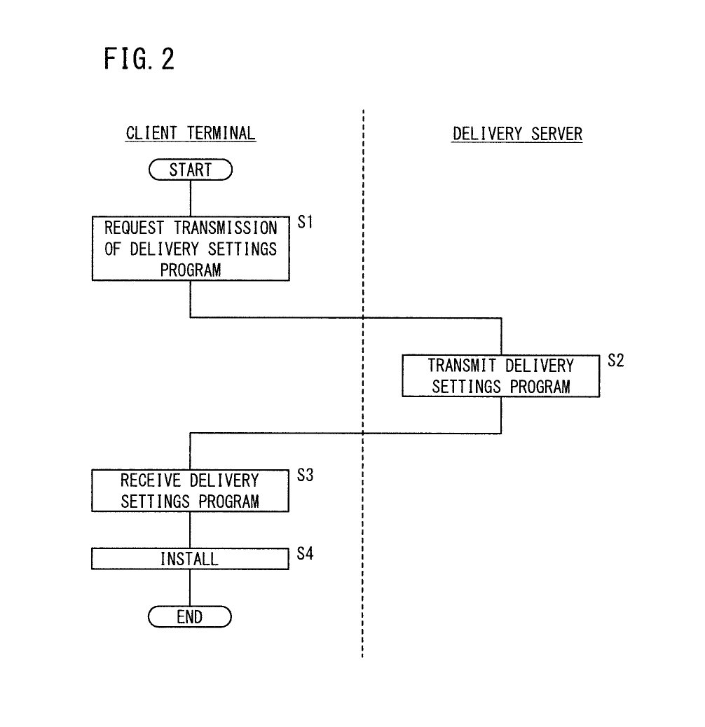

FIG. 2 is a flowchart of steps performed when the client terminal 12 acquires the delivery settings program Pd (PAAP). In step S1, in response to a user operation, the client terminal 12 issues a request to the server 14 to transmit the delivery settings program Pd (PAAP).

In step S2, responsive to the request from the client terminal 12, the server 14 transmits the delivery settings program Pd (PAAP) to the client terminal 12. The delivery settings program Pd (PAAP) is stored in the storage unit 68 of the server 14. In step S3, the client terminal 12 receives the delivery settings program Pd (PAAP), and in step S4, the client terminal 12, in response to a user operation, installs the delivery settings program Pd (PAAP).

It is not necessary that acquisition of the delivery settings program Pd (PAAP) be implemented from the server 14. For example, alternatively, the delivery settings program Pd (PAAP) can be obtained by way of online shopping via a website.

### 2-3. Input of Delivery Settings

### 2-3-1. First Time Input of Delivery Settings

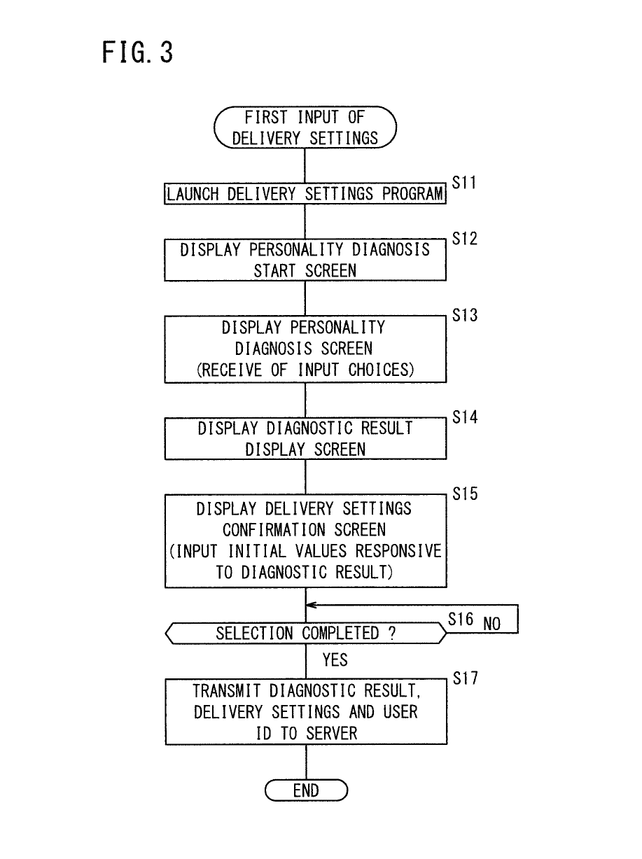

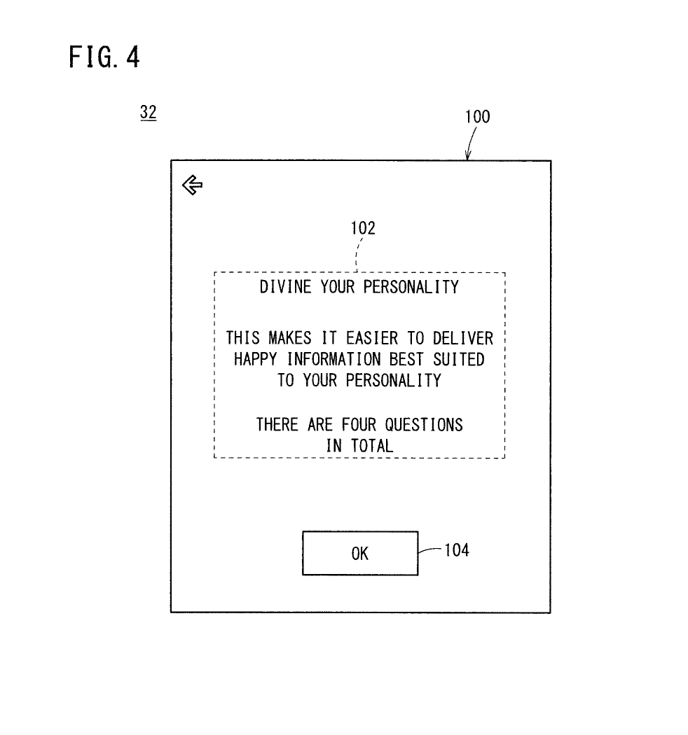

FIG. 3 is a flowchart of steps performed upon initial entry of delivery settings in the client terminal 12. In step S11, the client terminal 12 launches the delivery settings program Pd (PAAP) in response to a user operation (e.g., by the user selecting an icon). In step S12, the client terminal 12 (personality diagnosing unit 40) displays on the display 32 a personality diagnosis start screen 100 (hereinafter also referred to as a “screen 100”), as shown in FIG. 4.

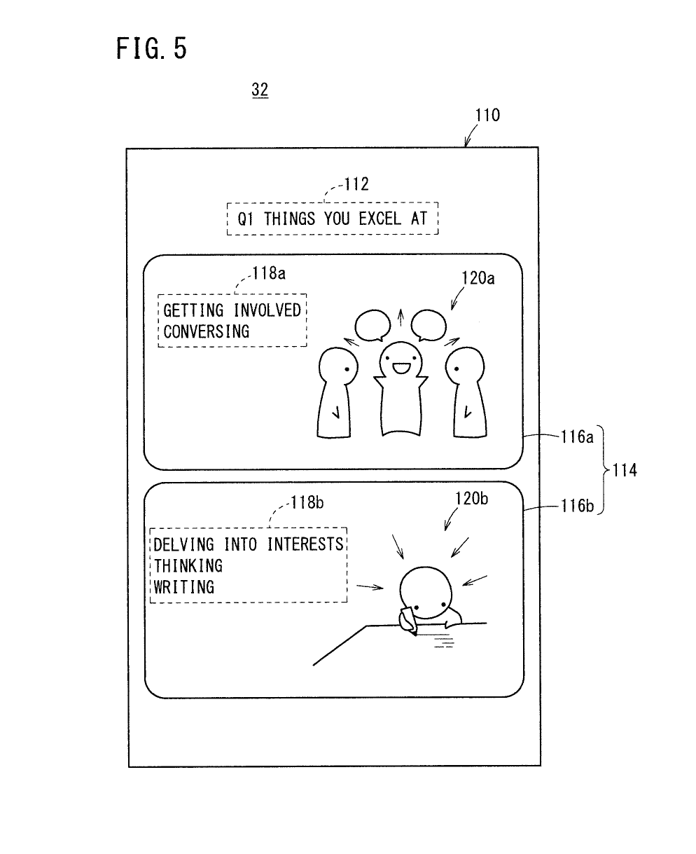

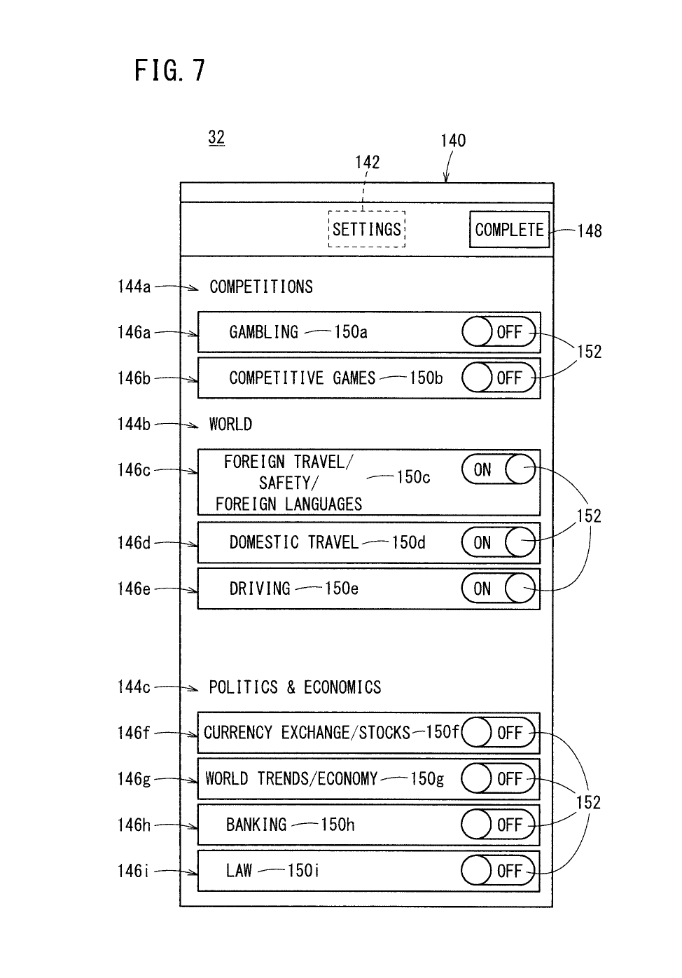

FIG. 4 is a view showing an example of the personality diagnosis start screen 100. The dashed line shown in FIG. 4 indicates an imaginary line (the same applies to FIGS. 5 and 7 as well). As shown in FIG. 4, in the center of the screen 100, a message 102 “DEVINE YOUR PERSONALITY THIS MAKES IT EASIER TO DELIVER POSITIVE INFORMATION SUITED TO YOUR PERSONALITY/THERE ARE FOUR QUESTIONS IN TOTAL” is displayed. Further, an OK button 104 is displayed below the message 102.

When the user presses the OK button 104, as will be described below, in step S13, the client terminal 12 (personality diagnosing unit 40) displays in succession on the display 32 four personality diagnosing screens 110 (hereinafter also referred to as “first through fourth screens 110” or “screens 110”), one example of which is shown in FIG. 5, in order to carry out a personality diagnosis of the user.

For performing the personality diagnosis, a psychological personality diagnostic method is used, which according to the present embodiment is implemented by way of a MBTI (Myers-Briggs Type Indicator) test. MBTI indicators are used to classify human personalities into sixteen (=2⁴) personality types, by use of four indicators from among Introversion (I), Extroversion (E), Sensing (S), Intuition (N), Thinking (T), Feeling (F), Judging (J), and Perceiving (P). For this purpose, in the present embodiment, four personality diagnosing screens 110 are used for carrying out the four questions.

More specifically, the first personality diagnosing screen 110 judges whether the user is an I (introverted) or an E (extroverted) type personality. The second personality diagnosing screen 110 judges whether the user is an S (sensing) or an N (intuition) type personality. The third personality diagnosing screen 110 judges whether the user is a T (thinking) or an F (feeling) type personality. The fourth personality diagnosing screen 110 judges whether the user is a J (judging) or a P (perceiving) type personality.

FIG. 5 is a view showing an example of the personality diagnosing screen 110. The example shown in FIG. 5 is of a screen, which is the first screen that is displayed from among the four screens 110 in total. A personality diagnosis of the user is carried out while the client terminal 12 (personality diagnosing unit 40) successively displays the four screens 110.

As shown in FIG. 5, a question 112 “Q1 THINGS YOU EXCEL AT”, which is the first question, is displayed on an upper side of the screen 110. Further, below the question 112, a group of choices 114 are displayed as answers to the question 112. The group of choices 114 includes a first choice 116a and a second choice 116b.

The first choice 116a includes a descriptive phrase 118a “GETTING INVOLVED/CONVERSING” together with an illustration 120a corresponding to the descriptive phrase 118a. The second choice 116b includes a descriptive phrase 118b “DELVING INTO INTERESTS/THINKING/WRITING” together with an illustration 120b corresponding to the descriptive phrase 118b.

Although the second through fourth screens from among the four screens 110 are not shown, in a similar manner to the first screen 110, each of the second through fourth screens includes a question 112, and a group of choices 114 including a first choice 116a and a second choice 116b.

More specifically, on the upper side of the second personality diagnosing screen 110, a question 112 is displayed, which is the second question “Q2 FREQUENT BEHAVIORS”. Below the question 112, a group of choices 114 is displayed including a first choice 116a and a second choice 116b.

The first choice 116a includes the descriptive phrase 118a “OBSERVE THINGS ONE BY ONE/KEEP RECORDS” together with an illustration 120a corresponding to the descriptive phrase 118a. The second choice 116b includes the descriptive phrase 118b “CREATE MENTAL IMAGES/SEE THE BIG PICTURE/LOOK TOWARD THE FUTURE” together with an illustration 120b corresponding to the descriptive phrase 118b.

On the upper side of the third personality diagnosing screen 110, a question 112 is displayed, which is the third question “Q3 WHEN MAKING JUDGMENTS”. Below the question 112, a group of choices 114 is displayed including a first choice 116a and a second choice 116b.

The first choice 116a includes the descriptive phrase 118a “PLACE EMPHASIS ON ANALYSIS/LOGICALLY/RATIONALLY” together with an illustration 120a corresponding to the descriptive phrase 118a. The second choice 116b includes the descriptive phrase 118b “RESPECT INDIVIDUAL DIFFERENCES STRIVE FOR HARMONY/VALUE PEOPLE'S FEELINGS” together with an illustration 120b corresponding to the descriptive phrase 118b.

On the upper side of the fourth personality diagnosing screen 110, a question 112 is displayed, which is the fourth question “Q4 IF YOU HAD TO CHOOSE ONE, YOU'D RATHER”. Below the question 112, a group of choices 114 is displayed including a first choice 116a and a second choice 116b.

The first choice 116a includes the descriptive phrase 118a “PREFER ORDERLINESS/HAVE AN ORGANIZED STATE OF AFFAIRS” together with an illustration 120a corresponding to the descriptive phrase 118a. The second choice 116b includes the descriptive phrase 118b “ACT FLEXIBLY ACCORDING TO THE SITUATION/LEAVE ROOM FOR CHANGE” together with an illustration 120b corresponding to the descriptive phrase 118b.

The user selects the first choice 116a or the second choice 116b on each of the screens 110. Stated otherwise, at each of the screens 110, the client terminal 12 (personality diagnosing unit 40) accepts input of either the first choice 116a or the second choice 116b.

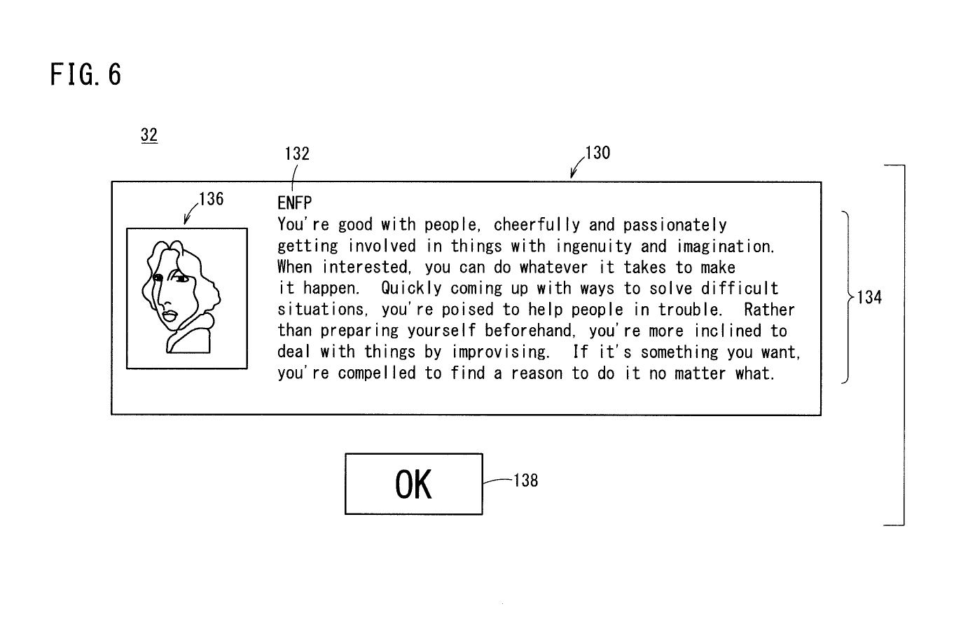

Returning to FIG. 3, after input of the first choice 116a or the second choice 116b has been accepted successively in each of the screens 110 (step S13), in step S14, the client terminal 12 (personality diagnosing unit 40) displays a diagnostic result display screen 130 (hereinafter also referred to as a “screen 130”), as shown in FIG. 6.

FIG. 6 is a view showing an example of the diagnostic result display screen 130. As shown in FIG. 6, in an upper central portion of the screen 130, a personality type 132 (in this case, “ENFP”) is shown as a diagnostic result, with a descriptive phrase 134 indicated below the personality type 132. On the lefthand side of the screen 130, an illustration 136 is shown that corresponds to the personality type 132 (ENFP). Further, an OK button 138 is displayed at the bottom of the screen 130.

When the user presses the OK button 138, in step S15 of FIG. 3, the client terminal 12 (initial settings controller 50) displays on the display 32 a delivery settings confirmation screen 140 (hereinafter also referred to as a “confirmation screen 140” or a “screen 140”), as shown in FIG. 7.

FIG. 7 is a view showing an example of the delivery settings confirmation screen 140. As shown in FIG. 7, on the confirmation screen 140 there are shown, respectively, a word 142 “SETTINGS” as the title of the screen 140, categories 144a through 144c of recommended information Irec, setting items 146a through 146i as sub-categories of the recommended information Irec, and a completion button 148. The sub-categories (setting items 146a through 146i) indicate detailed content for each of the categories 144a through 144c.

The setting items 146a through 146i include characters 150a through 150i indicative of content (category names) for each of the setting items. Further, the setting items 146a through 146i include ON/OFF buttons 152 (hereinafter also referred to as “buttons 152”) arranged to the right of the characters 150a through 150i. By operating the buttons 152, the user of the client terminal 12 can turn each of the settings on or off.

Although on the screen 140, the categories 144a through 144c and the setting items 146a through 146i are displayed, by scrolling the screen 140 up and down, other categories and setting items can be displayed. Hereinbelow, the term “categories 144” will be used to refer to the categories 144a through 144c as well as other categories that are not shown in FIG. 7. Further, the term “setting items 146” will be used to refer to the setting items 146a through 146i as well as other setting items that are not shown in FIG. 7.

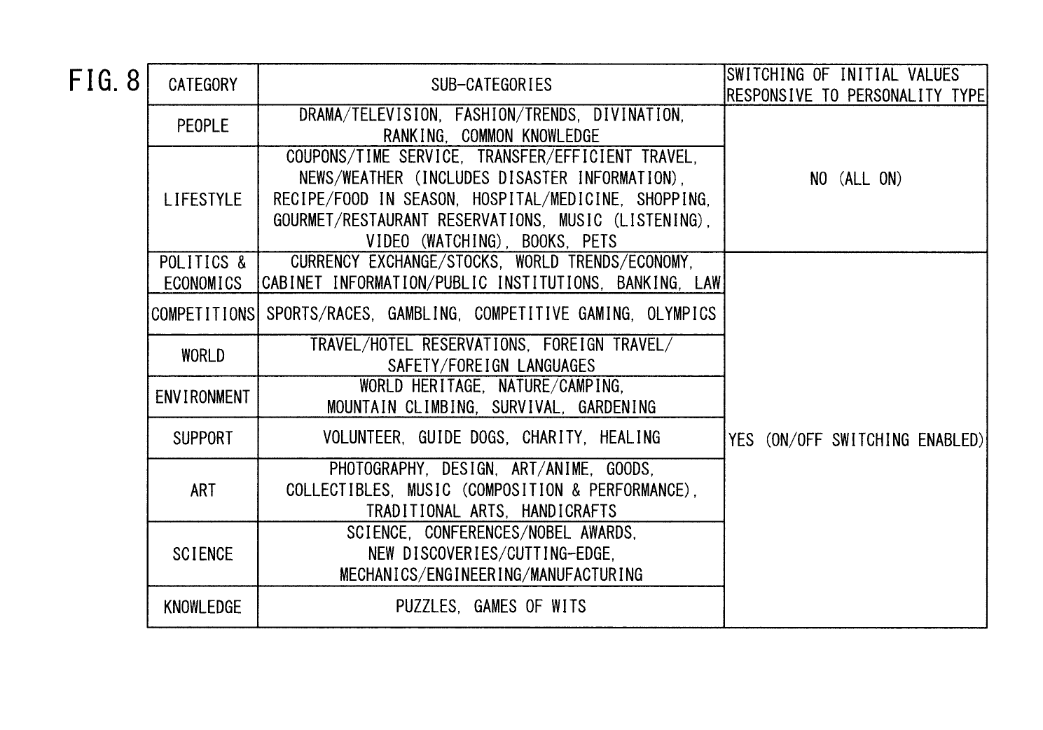

FIG. 8 is a view showing the presence or absence of switching of initial values corresponding to personality types, and categories and sub-categories of recommended information Irec to be delivered according to the present embodiment. For each of the categories (categories 144) shown in FIG. 8, sub-categories (setting items 146) are provided, the buttons 152 of which can be switched on or off by an operation of the user. As shown in FIG. 8, PEOPLE, LIFESTYLE, POLITICS & ECONOMICS, COMPETITIONS, WORLD, ENVIRONMENT, SUPPORT, ART, SCIENCE, and KNOWLEDGE are included as categories of the present embodiment, although the content categories are not limited to those illustrated in the figure. Further, in FIG. 7, only a portion of the categories (categories 144) and sub-categories (setting items 146) of FIG. 8 are shown, whereas the remaining categories and sub-categories are omitted from illustration or are shown by scrolling the screen 140 up and down.

When the buttons 152 corresponding to each of the setting items 146 are turned on, the recommended information Irec concerning the setting items 146 (categories) is delivered by way of push distribution from the server 14 to the client terminal 12.

Further, with the delivery settings confirmation screen 140 shown in FIG. 7, although delivery settings (settings for presence or absence of delivery) cannot be carried out for the sub-categories, delivery settings for the sub-categories may be carried out through the display of a sub-window or the like.

As shown in FIG. 8, with the present embodiment, a portion of the setting items 146 (i.e., POLITICS & ECONOMICS, COMPETITIONS, WORLD, ENVIRONMENT, SUPPORT, ART, SCIENCE, and KNOWLEDGE) is switched on or off corresponding to the result of the personality diagnosis (step S13 of FIG. 3). The remaining setting items 146 (i.e., PEOPLE and LIFESTYLE) are set on or off irrespective of the result of the personality diagnosis.

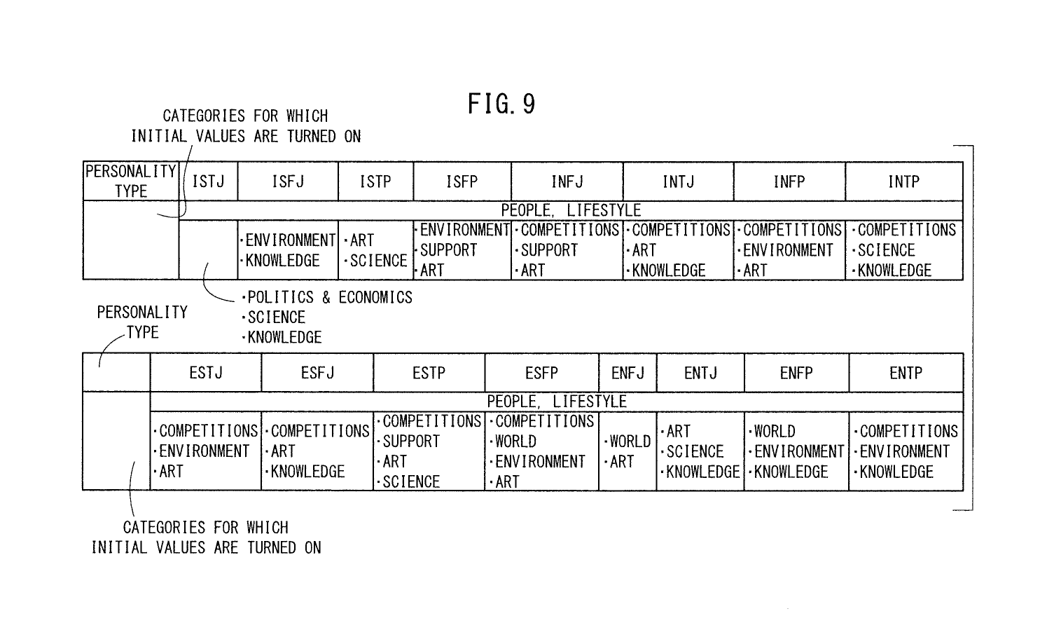

FIG. 9 is a view showing a relationship between personality types as judged by the personality diagnosis, and categories for which initial values of the delivery settings are turned on. As shown in FIG. 9, with the present embodiment, categories for which the recommended information Irec is delivered are changed for each of the personality types. For example, in the case that the personality type is ISTJ (introverted-sensing-thinking-judging), setting items 146 corresponding to “PEOPLE”, “LIFESTYLE”, “POLITICS & ECONOMICS”, “SCIENCE”, and “KNOWLEDGE” are turned on. Among these categories, the setting items 146 for the categories “PEOPLE” and “LIFESTYLE” are kept on, in common and irrespective of the personality types. On the other hand, the setting items 146 for the categories “POLITICS & ECONOMICS”, “SCIENCE”, and “KNOWLEDGE” are turned on responsive to the personality type.

The relationships shown in FIG. 9 are for the purpose of illustrating the initial values (initial settings) only. However, it should be noted that, on the delivery settings confirmation screen 140, the settings can be switched by operations of the user.

Returning to FIG. 3, in the case that the completion button 148 on the confirmation screen 140 (see FIG. 7) is not pressed and selection of the respective settings is not completed (step S16: NO), step S16 is repeated. On the other hand, in the case that the completion button 148 on the confirmation screen 140 is pressed and selection of the respective settings is completed (step S16: YES), the program proceeds to step S17. In step S17, the client terminal 12 transmits the personality type as a diagnostic result (step S13), the delivery settings (e.g., the sub categories for the recommended information Irec to be delivered) (step S16), and the user ID to the server 14.

### 2-3-2. Resetting of Delivery Settings

In the event that the delivery settings are reset (i.e., if input of the delivery settings is made a second time or more), the same processing used for initial input (see FIG. 3) of the delivery settings can be carried out. In this case, different questions (the questions 112) and different answer choices (the first choices 116a and the second choices 116b) may be used, which differ from those used when the delivery settings were input the first time.

### 2-4. Registration by Server 14

When the server 14 receives the personality type, the delivery settings, and the user ID from the client terminal 12 (step S17 of FIG. 3), the server 14 stores the selected content in association with the user ID in the user DB 90 (see FIG. 1). If there is existing information already stored in the user DB 90, the server 14 updates the information.

### 2-5. Distribution from Server 14 to Client Terminal 12 and Display on Client Terminal 12

The server 14 delivers recommended information Irec by way of push distribution to the client terminal 12, corresponding to the stored delivery settings (indicative of the recommended information Irec, etc., that should be transmitted). As described above, as the delivery settings, various settings are included, which are representative of the recommended information Irec that should be transmitted. Consequently, responsive to such settings, the server 14 delivers the recommended information Irec by way of push distribution.

The client terminal 12 receives the recommended information Irec that is delivered from the server 14 and displays the information on the display 32. The timing for display of the recommended information Irec in the client terminal 12, for example, can be immediately after the recommended information Irec is received. Alternatively, an icon (recommended information display icon) labeled “DISPLAY RECOMMENDED INFORMATION” may be provided on an initial screen (main menu screen) of the display 32, and the recommended information Irec may be displayed when the icon is selected.

Alternatively, in the event that current position information is transmitted at a predetermined timing (e.g., at fixed time intervals) from the client terminal 12 to the server 14, the recommended information Irec can be displayed at a timing corresponding to positions that occur thereafter. For example, surrounding information (information of facilities, event information, etc.), which is information in relation to things in the vicinity of the current position of the client terminal 12, is transmitted from the server 14 to the client terminal 12 together with the position information of the concerned vicinity. Thereafter, when the client terminal 12 arrives at a predetermined distance in proximity to the concerned vicinity, the client terminal 12 displays the surrounding information.

Alternatively, the recommended information Irec can be displayed at other timings (e.g., at an optional timing that is set by the server 14 and specified by the recommended information Irec).

### 3. Advantages of the Present Embodiment

In the foregoing manner, according to the present embodiment, initial values for the delivery settings (see FIG. 9) can be selected for carrying out push distribution according to user responses accompanying the personality diagnosis (step S15 of FIG. 3). Therefore, it is possible to alleviate the effort required from the user in relation to such delivery settings. In particular, it is possible to enhance user convenience when the delivery settings are first input.

Further, in the event that, among the delivery settings, there are items for which the content thereof is difficult to understand, items of which the user is unaware, or items that are mistaken by the user (e.g., items that the user has decided are unnecessary, but in actuality, such items would be of great interest to the user), it is possible for delivery settings to be made that are beneficial to the user. In particular, with the present embodiment, by way of the personality diagnosis, it is highly possible for information to be delivered that is beneficial to the user, without forcing the user to possess a deep understanding in relation to the delivery settings.

Furthermore, the results of the personality diagnosis can be used as representing the user's personality. Thus, by associating the results of the personality diagnosis and the delivery settings using psychological knowledge, delivery settings can be realized which are more beneficial or advantageous for the user.

In the present embodiment, the client terminal 12 displays the delivery settings confirmation screen 140 (see FIG. 7) by which the delivery settings, which correspond to the selected choices (the first choice 116a or the second choice 116b), are selected as initial values (step S15 of FIG. 3). By means of the screen 140, the delivery settings can be changed responsive to an operation of the user. Consequently, compared to the case of confirming the delivery settings responsive to results of the personality diagnosis, the will of the user can be more easily reflected. Therefore, it is possible to carry out delivery of information while respecting the intention of the user. In the present embodiment, in addition to the sub-categories of the categories “POLITICS & ECONOMICS” and “COMPETITIONS” (see FIGS. 8 and 9), which are delivery settings (variable initial value settings) selected as initial values corresponding to the selected choices (the first choice 116a and/or the second choice 116b), the client terminal 12 selects as delivery settings the sub-categories of the categories “PEOPLE” and “LIFESTYLE” (see FIGS. 8 and 9), which are delivery settings (fixed initial value settings) that are specified without relation to the selection of such choices.

Owing thereto, delivery settings (variable initial value settings) in which the initial values therefor are variable corresponding to results of the personality diagnosis can be used together with delivery settings (fixed initial value settings) in which initial values therefor are set irrespective of the results of the personality diagnosis. Along therewith, unintentional omission of settings concerning delivery settings that are normally necessary (for example, delivery of disaster information) can be prevented.

### B. Modifications

The present invention is not limited to the embodiment described above. Various modified or additional configurations can be adopted based on the content disclosed in the present specification. For example, the following modified configurations can be adopted.

### 1. Client Terminal 12

In the above embodiment, the client terminal 12 comprises a smart phone. However, for example, so long as the client terminal 12 is capable of receiving various information (recommended information Irec), which is delivered from the server 14 by way of push distribution, the client terminal 12 may comprise a different type of configuration (e.g., a tablet computer, a notebook type personal computer (PC), or a desktop PC).

### 2. Delivery Settings Program Pd

In the above embodiment, the software (delivery settings program Pd) for carrying out the delivery settings is used upon being downloaded to the client terminal 12 from the server 14 (see FIG. 2). However, so long as the client terminal 12 is capable of allowing the delivery settings to be made for enabling delivery by way of push distribution from the server 14 to the client terminal 12, the manner in which the delivery settings are implemented is not limited. For example, the delivery settings may be implemented through a so-called ASP (application service provider) without downloading the delivery settings program Pd. 3. Personality Diagnosing Screen 110

In the above embodiment, a total of four questions are asked through use of the four personality diagnosing screens 110. However, for example, from the standpoint of enabling selection of delivery settings responsive to the result of the personality diagnosis, the invention is not limited to this feature. For example, a different number of screens 110 or a different number of questions may be used.

In the above embodiment, both of the responses (choices 116a, 116b) are displayed at the same time with respect to one question (question 112) on each of the personality diagnosing screens 110 (see FIG. 5). However, from the standpoint of selecting delivery settings responsive to the result of the personality diagnosis, the invention is not limited to this feature. For example, a question (question 112) may be displayed, and after the question is canceled from the screen 110, the responses (choices 116a, 116b) to the question may be displayed. Alternatively, multiple questions (questions 112) may be displayed, and responses (choices 116a, 116b) corresponding thereto can be displayed at the same time on one screen 110.

In the above embodiment, illustrations 120a, 120b are included with each of the choices 116a, 116b on the screen 110 (see FIG. 5). However, for example, insofar as the delivery settings can be selected responsive to the result of the personality diagnosis, the illustrations 120a, 120b need not necessarily be displayed. 4. Delivery Settings Confirmation Screen 140

In the above embodiment, categories (POLITICS & ECONOMICS, COMPETITIONS, etc.), which are switched on or off responsive to the result of the personality diagnosis, and categories (PEOPLE and LIFESTYLE), which are set in a fixed manner irrespective of the result of the personality diagnosis, are both provided (see FIGS. 8 and 9). However, for example, from the standpoint of selecting delivery settings corresponding to the result (personality type) of the personality diagnosis, only categories that are switched on or off responsive to the result of the personality diagnosis can be provided.

In the above embodiment, the delivery settings, which are selected responsive to the result of the personality diagnosis, are used for establishing categories (or sub-categories) for which recommended information Irec is to be delivered (see FIG. 8). However, for example, from the standpoint of selecting delivery settings responsive to the result (personality type) of the personality diagnosis, the invention is not limited to this feature. For example, the frequency at which the recommended information Irec is delivered, or the like, can be used as delivery settings that are selected responsive to the personality diagnosis.

In the above embodiment, delivery settings corresponding to the result of the personality diagnosis are shown on the delivery settings confirmation screen 140 (see FIG. 7). However, for example, insofar as the delivery settings are selected responsive to the result (personality type) of the personality diagnosis, the delivery settings may be selected responsive to the personality diagnosis in the server 14 or the client terminal 12, without undergoing the confirmation step on the screen 140.

In the above embodiment, the delivery settings confirmation screen 140 (step S15) is displayed immediately upon completion of the personality diagnosis (step S14 of FIG. 3). However, from the standpoint of enabling selection of delivery settings responsive to the result of the personality diagnosis, for example, the personality diagnosis, and display of the confirmation screen (screen 140) corresponding thereto may be carried out at any given time interval. For example, directly after the personality diagnosis, a personal information input screen by which the user's name, age, and address are input may be displayed, and the delivery settings confirmation screen 140 may be displayed thereafter.

In the above embodiment, the delivery settings shown in FIG. 8 are provided as selectable settings. However, for example, from the standpoint of selecting delivery settings responsive to the result of the personality diagnosis, the selectable delivery settings are not limited to the features shown in FIG. 8.

### 5. Information Sent from Client Terminal 12 to Server 14

In the above embodiment, as information that is transmitted to the server 14 from the client terminal 12, there are included the personality type as a diagnostic result, the categories of recommended information Irec to be delivered, and the user ID (step S17 of FIG. 3). However, from the standpoint of selecting delivery settings responsive to the result of the personality diagnosis, the invention is not limited to this feature, so long as at least one of the delivery settings corresponding to the choices 116a, 116b of the personality diagnosis is included. For example, only the personality type can be transmitted to the server 14. Alternatively, only the categories of the recommended information Irec to be delivered can be transmitted to the server 14.

In the above embodiment, specification of the delivery settings corresponding to the personality type as a diagnostic result is carried out in the client terminal 12, and the delivery settings are transmitted to the server 14 from the client terminal 12. However, for example, from the standpoint of selecting delivery settings responsive to the result of the personality diagnosis, the personality type as a diagnostic result may be transmitted from the client terminal 12 to the server 14, and the delivery settings may be selected in the server 14. More specifically, the server 14 may select the delivery settings corresponding to the personality type that is received from the client terminal 12.

### 6. Other Features

In the above embodiment, for purposes of the personality diagnosis, the personality diagnosing screen 110 is used as a means by which questions are presented to the user, and responses to the questions are obtained (see FIG. 5). However, for example, from the standpoint of selecting delivery settings responsive to the result of the personality diagnosis, in addition to or in place of the screen 110, the questions and response choices may be output audibly by voice from the client terminal 12, and responses thereto can be received by speech from the user. Alternatively, the questions and response choices may be output audibly by voice from the client terminal 12, and responses from the user can be accepted by the operating unit 26 (touch panel) of the client terminal 12. Alternatively, the questions and response choices may be displayed on the screen 110, and responses thereto can be received by speech from the user.

In the above embodiment, the present invention is applied to the information delivery system 10 by which the recommended information Irec is delivered from the server 14 by way of push distribution to the client terminal 12 (see FIG. 1). However, for example, insofar as settings can be input automatically responsive to the result of the personality diagnosis, the invention is not limited to this feature. For example, the present invention can be applied to an information delivery system by which the recommended information Irec is delivered from the server 14 by way of pull distribution to the client terminal 12. With such a system, for example, the result of the personality diagnosis is included in a request from the client terminal 12 to the server 14. In addition, the selection of recommended information Irec, which is delivered to the client terminal 12 from the server 14, is carried out responsive to the result of the personality diagnosis.

What is claimed is:

1. An information delivery system comprising a client terminal, and a server that carries out push distribution of various information with respect to the client terminal, wherein the client terminal is configured to:
display a personality diagnosing screen by which a question for diagnosing the personality of a user, and multiple choices as answers to the question are displayed;
after any of the multiple choices have been selected by the user, select as initial values delivery settings corresponding to the selected multiple choices; and
transmit the delivery settings to the server in form of the initial values as is, or after changes have been made thereto by the user; and
the server carries out push distribution of the various information with respect to the client terminal, corresponding to the delivery settings received from the client terminal.

2. The information delivery system according to claim 1, wherein the client terminal displays a delivery settings confirmation screen by which the delivery settings corresponding to the selected choices are selected as the initial values, the delivery settings confirmation screen enabling the delivery settings to be changed responsive to an operation of the user.

3. The information delivery system according to claim 1, wherein, in addition to variable initial value settings, which make up the delivery settings selected as initial values corresponding to the selected choices, the client terminal selects as the delivery settings fixed initial value settings, which make up delivery settings that are specified without relation to the selection of the choices.

4. A client terminal, which receives by way of push distribution various information from a server, wherein the client terminal is configured to:
display a personality diagnosing screen by which a question for diagnosing the personality of a user, and multiple choices as answers to the question are displayed;
after any of the multiple choices have been selected by the user, select as initial values delivery settings corresponding to the selected multiple choices; and
transmit the delivery settings to the server in form of the initial values as is, or after changes have been made thereto by the user.
